(19) United States
(12) Patent Application Publication
(10) Pub. No.: US 2013/0324389 A1
(43) Pub. Date: Dec. 5, 2013

(54) GLASS COMPOSITION, GLASS SUBSTRATE FOR SOLAR CELLS USING GLASS COMPOSITION, AND GLASS SUBSTRATE FOR DISPLAY PANEL

(71) Applicant: Asahi Glass Company, Limited, Chiyoda-ku (JP)

(72) Inventors: Tatsuo NAGASHIMA, Tokyo (JP); Yuki KONDO, Tokyo (JP); Manabu NISHIZAWA, Tokyo (JP); Akio KOIKE, Tokyo (JP)

(73) Assignee: Asahi Glass Company, Limited, Chiyoda-ku (JP)

(21) Appl. No.: 13/960,461

(22) Filed: Aug. 6, 2013

Related U.S. Application Data
(63) Continuation of application No. PCT/JP2012/052468, filed on Feb. 3, 2012.

(30) Foreign Application Priority Data
Feb. 8, 2011 (JP) 2011-025148

(51) Int. Cl. C03C 3/091; C03C 3/087

(52) U.S. Cl. CPC C03C 3/091; C03C 3/087
USPC 501/66; 501/70

(57) ABSTRACT

The present invention relates to a glass composition including, in terms of mol % on the basis of oxides: from 55 to 70% of SiO₂, from 5 to 10% of Al₂O₃, from 0 to 0.5% of B₂O₃, from 3 to 15% of MgO, from 3 to 15% of CaO, from 2 to 10% of SrO, from 1 to 10% of BaO, from 0 to 3% of ZrO₂, from 0 to 1.8% of Na₂O, and from 0 to 1% of K₂O, provided that MgO+CaO+SrO+BaO is from 20 to 35%, and Na₂O+K₂O is from 0 to 2%, in which the glass composition has a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower.

### TECHNICAL FIELD

The present invention relates to a glass composition, and a glass substrate comprising the glass composition. In more detail, the invention relates to a glass composition for a glass substrate for solar cells in which a photoelectric conversion layer is formed between glass substrates, a glass composition for an evacuated glass tube type heat collector for performing solar thermal power generation by evaporating a heating medium heated in a heat collector by solar heat to rotate a steam turbine and the like, and a glass composition for a glass substrate for a display panel used in various display panels.

The present invention further relates to a glass substrate for solar cells typically having a glass substrate and a cover glass, in which a photoelectric conversion layer comprising group 11-13 or 11-16 compound semiconductors having a chalcopyrite crystal structure, or cubic or hexagonal group 12-16 compound semiconductors, as main components is formed between the glass substrate and the cover glass, and particularly relates to a glass substrate for a Cu—In—Ga—Se solar cell or a glass substrate for a CdTe solar cell.

The present invention further relates to a glass substrate for a display panel, used in various display panels such as a liquid crystal display (LCD) panel, an organic EL display panel or a plasma display panel (PDP), specifically a glass substrate for display in which an oxide semiconductor such as IGZO, or an organic semiconductor such as pentacene, is used in a thin film transistor (TFT) (hereinafter referred to as a “glass substrate for TFT display panel”), and particularly relates to a glass substrate for an organic EL display panel.

### BACKGROUND OF THE INVENTION

Group 11-13 or 11-16 compound semiconductors having a chalcopyrite crystal structure, or a cubic or hexagonal group 12-16 compound semiconductors have large absorption coefficient to light in a wavelength range of from visible light to near-infrared light, and is therefore expected as a material of highly-efficient thin film solar cells. Representative examples include Cu(In, Ga)Se₂ system (hereinafter referred to as “CIGS”), Cu₂ZnSnSe₄ system in which In, Ga and the like in CIGS are substituted (hereinafter referred to as “CZTS”), and CdTe.

Conventionally, in a CIGS thin film solar cell, a soda-lime glass is used as a substrate for the reasons that the glass is inexpensive and has an average thermal expansion coefficient close to that of a CIGS compound semiconductor, and solar cells are obtained.

Furthermore, to obtain efficient solar cells, a glass material capable of withstanding heat treatment temperature with relatively high temperature is proposed (see Patent Document 1).

The glass composition in this case contains an alkali metal oxide to diffuse an alkali metal in a CIGS layer. On the other hand, for the prevention of unevenness of diffusion of an alkali metal in a CIGS layer plane from a glass substrate, a CIGS solar cell having an alkali metal-doped CIGS layer, provided on a glass substrate having an alkali metal diffusion barrier layer or on an alkali metal oxide-free substrate, is proposed (see Patent Document 2).

Incidentally, as uses of a glass composition, a glass tube for an evacuated glass tube type heat collector used in collecting solar heat (see Patent Document 3) has been known.

On the other hand, an alkali-free glass that does not contain an alkali metal oxide is conventionally used in a glass substrate for a display panel. The reason for this is that if an alkali metal oxide is contained in a glass substrate, alkali metal ions in the glass substrate diffuse in a semiconductor film of a thin film transistor (TFT) used to drive a display panel during the heat treatment carried out in a production process of the display panel, and this may lead to deterioration of TFT characteristics.

However, the alkali-free glass has very high viscosity, has the property that melting is difficult, and therefore involves technical difficulty in the production. By recent technical progress, use of an alkali glass substrate containing an alkali metal oxide as a glass substrate for a display panel is beginning to be considered (see Patent Document 4).

### BACKGROUND ART

### Patent Document

Patent Document 1: JP-A-11-135819
Patent Document 2: JP-A-8-222750
Patent Document 3: JP-B-60-11301
Patent Document 4: JP-A-2006-137631

### SUMMARY OF THE INVENTION

### Problems that the Invention is to Solve

However, in the case of sufficiently containing an alkali metal oxide as disclosed in the examples of Patent document 1, there was a problem that this leads to the decrease in a glass transition temperature (Tg).

On the other hand, in the case of using an alkali-free glass as a substrate that does not contain an alkali metal oxide as described in Patent Document 2, the alkali-free glass generally has a glass melting temperature about 100° C. higher than that of an alkali metal oxide-containing glass. Therefore, there is a problem that this leads to the decrease in productivity when melting a glass or forming a glass, and the decrease in refining. Furthermore, for example, when used as a glass substrate for a CIGS solar cell, a thermal expansion coefficient of the glass substrate differs from that of a CIGS layer as a photoelectric conversion layer. Therefore, there is a problem that this leads to peeling during film-formation or after film-formation of the CIGS layer on the glass substrate.

The evacuated glass tube type heat collector is required to match a thermal expansion coefficient between a tube glass and a tube-sealing member such as a glass frit or a metal end plate, and is further required to have thermal impact resistance of the glass tube.

Furthermore, in recent years, use of an organic EL display is investigated in display panels for the purpose of the reduction in thickness and energy saving. However, the organic EL is current drive, and therefore, long-tern driving stability of TFT becomes important as compared with the conventional LCD. As disclosed in the working examples of Patent Document 4, in the case of sufficiently containing an alkali metal oxide, there may be a concern from the standpoints of long-term driving stability of a display device, film peeling and the like. Particularly, in a large-sized organic EL television, current and voltage of a driving circuit are increased, and the problem on long-term driving stability becomes remarkable.

Thus, it was difficult in the glass composition to have high glass transition temperature, a given average thermal expansion coefficient and low melting temperature in good balance.

The present invention has an object to provide a glass composition having high glass transition temperature, a given average thermal expansion coefficient and low melting temperature in good balance, and a glass substrate for solar cells, comprising the glass composition, particularly a glass substrate for a CIGS solar cell and a glass substrate for a CdTe solar cell, and a glass substrate for a display panel, specifically, for example, a glass substrate for a TFT display panel, and particularly a glass substrate for an organic EL display panel.

### Means for Solving the Problems

The present invention is as follows.

(1) A glass composition comprising, in terms of mol % on the basis of oxides:

from 55 to 70% of SiO₂,

from 5 to 10% of Al₂O₃.

from 0 to 0.5% of B₂O₃,

from 3 to 15% of MgO,

from 3 to 15% of CaO,

from 2 to 10% of SrO,

from 1 to 10% of BaO,

from 0 to 3% of ZrO₂,

from 0 to 1.8% of Na₂O, and

from 0 to 1% of K₂O,

provided that MgO+CaO+SrO+BaO is from 20 to 35%, and Na₂O+K₂O is from 0 to 2%,

wherein the glass composition has a glass transition temperature of 680° C. or higher, an average thermal expansion coefficient of from 50×10⁻⁷ to 70×10⁻⁷/° C. and a temperature at which a viscosity is 10² dPa·s of 1,600° C. or lower.

(2) The glass composition according to [1], comprising, in terms of mol % on the basis of oxides:

from 55 to 70% of SiO₂,

from 5 to 10% of Al₂O₃,

from 0 to 0.5% of B₂O₃,

from 3 to 15% of MgO,

from 3 to 15% of CaO,

from 2 to 10% of SrO,

from 1 to 10% of BaO,

from 0 to 3% of ZrO₂,

from 0 to 1% of Na₂O, and

from 0 to 1% of K₂O,

provided that MgO CaO+SrO+BaO is from 20 to 35%, and Na₂O+K₂O is from 0 to 1.5%.

wherein the glass composition has a glass transition temperature of 680° C. or higher, an average thermal expansion coefficient of from 50×10⁻⁷ to 70×10″⁷/° C., and a temperature at which a viscosity is 10² dPa·s of 1,600° C. or lower.

(3) The glass composition according to (1) or (2), comprising, in terms of mol % on the basis of oxides:

from 59 to 67% of SiO₂,

from 5 to 8% of Al₂O₃,

from 0 to 0.3% of B₂O₃,

from 6 to 10% of MgO,

from 6 to 10% of CaO,

from 3 to 9% of SrO,

from 2 to 7% of BaO,

from 0 to 1% of ZrO₂,

from 0 to 1% of Na₂O, and

from 0 to 1% of K₂O,

provided that MgO+CaO+SrO+BaO is from 24 to 29%, and Na₂O+K₂O is from 0 to 1.5%,

wherein the glass composition has a glass transition temperature of 700° C. or higher, an average thermal expansion coefficient of from 50×10⁻⁷ to 60×10⁻⁷/° C., and a temperature at which a viscosity is 10² dPa·s of 1,580° C. or lower.

(4) A glass substrate for solar cells, comprising the glass composition according to any one of (1) to (3).

(5) A glass substrate for a CIGS solar cell, comprising the glass composition according to any one of (1) to (3).

(6) A glass substrate for a CdTe solar cell, comprising the glass composition according to any one of (1) to (3).

(7) A glass substrate for a display panel, comprising the glass composition according to any one of (1) to (3).

### Advantage of the Invention

The glass composition of the present invention can have high glass transition temperature, a given average thermal expansion coefficient and low melting temperature in good balance. By using the glass composition of the present invention, a glass composition for solar cells having high power generation efficiency, a tube glass for an evaluated glass tube type heat collector having high solar heat collection efficiency, and a glass substrate for a display panel having excellent long-term driving stability can be provided. Furthermore, a glass substrate and a tube glass having high productivity and high quality when manufacturing the glass can be obtained.

The disclosure of the present invention is associated with the subject matter described in Application No. 2011-025148 filed Feb. 8, 2011, and the disclosure thereof is incorporated herein by reference.

### MODE FOR CARRYING OUT THE INVENTION

### <Glass Composition of Present Invention>

The glass composition of the present invention is described below.

The glass composition of the present invention is a glass composition comprising, in terms of mol % on the basis of oxides:

from 55 to 70% of SiO₂,

from 5 to 10% of Al₂O₃,

from 0 to 0.5% of B₂O₃,

from 3 to 15% of MgO,

from 3 to 15% of CaO,

from 2 to 10% of SrO,

from 1 to 10% of BaO,

from 0 to 3% of ZrO₂,

from 0 to 1.8% of Na₂O, and

from 0 to 1% of K₂O,

provided that MgO+CaO+SrO+BaO is from 20 to 35%, and Na₂O+K₂O is from 0 to 2%,

wherein the glass composition has a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower.

The glass transition temperature (Tg) of the glass composition of the present invention is 680° C. or higher in order to secure formation of a photoelectric conversion layer of a glass substrate for solar cells such as CIGS, CZTS or CdTe (prevention of photoelectric conversion layer breakage by thermal deformation of a glass when film-forming a photoelectric conversion layer), to obtain thermal impact resistance of a tube glass and to reduce deformation and thermal shrinkage of a glass substrate for a display panel in a TFT production process. The glass transition temperature of the glass composition of the present invention is higher than the glass transition temperature of a soda-lime glass. The glass transition temperature is preferably 700° C. or higher, and more preferably 710° C. or higher.

From the same reason, strain point (Tₛₚ) is preferably 630° C. or higher, more preferably 650° C. or higher, and still more preferably 660° C. or higher.

Moreover, annealing point (Tₐₚ) of the glass of the present invention is preferably 780° C. or lower. In the case where the annealing point exceeds 780° C., an annealing initiation temperature is increased in annealing a sheet glass or a tube glass after forming, and time required for annealing is prolonged. This may lead to the decrease in productivity and the increase in costs. The annealing point is more preferably 750° C. or lower, and still more preferably 740° C. or lower.

The average thermal expansion coefficient at from 50 to 350° C. of the glass composition of the present invention is from 50×10⁻⁷ to 70×10⁻⁷/° C. In the case where the average thermal expansion coefficient is less than 50×10⁻⁷/° C. or exceeds 70×10⁻⁷/° C., in the case of using the glass composition in a glass substrate for solar cells, difference in thermal expansion between an Mo electrode layer and a CdTe layer becomes too large, and the defect such as film peeling occur easily. Furthermore, in the case of using the glass composition of the present invention in a substrate for a display panel, there is a tendency to become difficult to achieve both matching to a peripheral panel member such as a metal and dimensional stability in a heating step.

The average thermal expansion coefficient is preferably 65×10⁻⁷/° C. or less, and more preferably 60×10⁻⁷/° C. or less, in order to match the thermal expansion coefficient between a tube glass and a tube-sealing member such as a glass frit or a metal end plate in the case of using the glass composition of the present invention in a tube glass for an evacuated glass tube type heat collector, and in order to further improve dimensional stability, in the case of using the glass composition of the present invention in a high definition display panel such as a super high definition television or a mobile device.

In view of melting performance and refining of a glass, according to the glass composition of the present invention, a temperature (T₂) at which a viscosity is 10² dPa·s is 1,600° C. or lower. The T₂ is preferably 1,580° C. or lower, and more preferably 1,560° C. or lower.

Moreover, in view of formability of a sheet glass or a tube glass, according to the glass composition of the present invention, a temperature (T₄) at which a viscosity is 10⁴ dPa·s is preferably 1,240° C. or lower, more preferably 1,220° C. or lower, and further 1,200° C. or lower, and particularly preferably 1,180° C. or lower.

Also, according to the glass composition of the present invention, it is preferable that the relationship between the temperature (T₄) at which a viscosity is 10⁴ dPa·s and a devitrification temperature (T_{L}) is T₄−T_{L}≧−70° C. In the case where the T₄−T_{L} is less than −70° C., devitrification occurs easily when forming a sheet glass, and forming of a sheet glass may be difficult. The T₄−T₁, is preferably −50° C. or more, more preferably −30° C. or more, still more preferably 0° C. or more, particularly preferably 10° C. or more, and most preferably 20° C. or more.

The devitrification temperature used here means the maximum temperature at which crystals do not formed on the surface of a glass and in the inside thereof when maintaining the glass at specific temperature for 17 hours.

In the glass composition of the present invention, it is preferable that a density thereof is 2.9 g/cm³ or less. In the case where the density exceeds 2.9 g/cm³, weight of a product is increased, which is not preferred. The density is more preferably 2.8 g/cm³ or less, and still more preferably 2.7 g/cm³ or less.

In the case of using the glass composition of the present invention in a substrate for a CdTe solar cell and a tube glass for an evacuated glass type heat collector, in view of power generation efficiency, an average transmittance of the glass composition at a wavelength of from 450 to 1,100 nm is preferably 86% or more in terms of 1 mm thickness when a glass substrate is formed. The average transmittance is more preferably 90% or more, and still more preferably 92% or more. Even in the case of using the glass composition in a glass substrate for a display panel, the similar average transmittance is required from the standpoints of high brightness and color reproducibility.

The transmittance of the glass composition at a wavelength of 400 nm is preferably 85% or more in terms of 1 mm thickness when a glass substrate is formed. In the case where the transmittance is less than 85%, power generation efficiency of a solar cell and a solar heat collector may be decreased. Furthermore, in the case where the transmittance is less than 85%, when used over a long period of time, the glass causes solarization by sunlight, and power generation efficiency may be further decreased. Furthermore, in the case where the transmittance is less than 85%, in the case of using the glass composition of the present invention in a glass substrate for a display panel, it is difficult to efficiently perform UV curing in a sealing step in the production of a panel. The transmittance is more preferably 88% or more, and still more preferably 90% or more.

Moreover, according to the glass composition of the present invention, it is preferable that the amount of alkali metal and alkaline earth metal elements precipitated on the surface of the glass after maintaining in a water vapor atmosphere at 120° C. under 0.2 MPa for 20 hours is 300 ng/cm² or less. In the case where the amount exceeds 300 ng/cm², in the case of using the glass composition in a glass substrate for solar cells, a tube glass for an evacuated glass tube type heat collector and a glass substrate for a display panel, weather resistance tends to be decreased. The amount is more preferably 200 ng/cm² or less, and still more preferably 100 ng/cm² or less.

Also, according to the glass composition of the present invention, it is preferable that a photoelastic constant is 29 nm/MPa/cm or less. In the case where the photoelastic constant exceeds 29 nm/MPa/em, in the case of using the glass composition of the present invention in a glass substrate for a display panel (particularly, a glass substrate for a liquid crystal display (LCD) panel), the decrease in display quality by a birefringence caused in a glass substrate by stress and the like generated in an LCD panel may be remarkable. The photoelastic constant is more preferably 28 nm/MPa/cm or less, still more preferably 27 nm/MPa/cm or less, and even more preferably 26 nm/MPa/em or less.

Also, according to the composition of the present invention, it is preferable Young's modulus is 79 GPa or more. In the case where the Young's modulus is less than 79 GPa, in the case of using the glass composition of the present invention in a glass substrate for a display panel (particularly a glass substrate for a liquid crystal display (LCD) panel), disadvantages due to deflection and deformation of a glass by own weight, stress from the outside, and the like may occur in a glass substrate used in an LCD production process and a glass substrate of an LCD panel as a product. The Young's modulus is more preferably 81 GPa or more, still more preferably 83 GPa or more, and even more preferably 85 GPa or more.

The reason for limiting to the above matrix composition in the glass composition of the present invention is as follows.

SiO₂: SiO₂ is a component for forming a network of a glass. In the case where the content of this component is less than 55 mol % (hereinafter simply referred to as “%”), heat resistance, Young's modulus and chemical durability of the glass are decreased, and an average thermal expansion coefficient may be increased. The content is preferably 57% or more, more preferably 59% or more, and still more preferably 62% or more.

However, in the case where the content exceeds 70%, high temperature viscosity of a glass is increased, and the problem may occur that melting performance is deteriorated. Therefore, the content is preferably 69% or less, more preferably 68% or less, and still more preferably 67% or less.

Al₂O₃: Al₂O₃ increases a glass transition temperature, and improves weather resistance, chemical durability, heat resistance and Young's modulus. In the case where the content is less than 5%, a glass transition temperature may be decreased. Furthermore, an average thermal expansion coefficient may be increased. The content is preferably 5.5% or more.

However, in the case where the content exceeds 10%, high temperature viscosity of a glass is increased, and melting performance may be deteriorated. Furthermore, devitrification temperature is increased, and formability may be deteriorated. Furthermore, in the case using in a glass substrate for solar cells, power generation efficiency may be decreased. The content is preferably 9% or less, and more preferably 8% or less.

B₂O₃ may be contained up to 0.5% in order to lower a density and to improve melting performance. In the case where the content exceeds 0.5%, a photoelastic constant is increased, and in the case of using in a glass substrate for solar cells, when forming a CIGS layer or a CdTe layer as a photoelectric conversion layer, boron ions diffuse in those layers, and this may lead to the decrease in power generation efficiency. Furthermore, the amount of evaporation of B₂O₃ when melting a glass is increased, and facility load may be increased. The content is preferably 0.3% or less, and more preferably B₂O₃ is not substantially contained.

Incidentally, the term “not substantially contained” means that a component is not contained other than unavoidable impurities mixed from raw materials and the like, that is, means that the component is not intentionally contained.

MgO: MgO is contained in an amount of from 3 to 15% in order to improve chemical durability, Young's modulus and weather resistance and to decrease a density. In the case where the content is less than 3%, chemical durability and weather resistance tend to be not sufficiently obtained. The content is preferably 5% or more, and more preferably 6% or more. In the case where the content exceeds 15%, the tendency to devitrificate a glass is increased. The content is preferably 12% or less, and more preferably 10% or less.

CaO: CaO is contained in an amount of from 3 to 15% in order to decrease high temperature viscosity or to increase an average thermal expansion coefficient. In the case where the content is less than 3%, high temperature viscosity is not sufficiently decreased, and melting performance tends to be deteriorated, or an average thermal expansion coefficient tends to be excessively decreased. The content is preferably 5% or more, and more preferably 6% or more. On the other hand, in the case where the content exceeds 15%, the tendency to devitrify a glass is increased, and chemical durability and weather resistance tend to be decreased. The content is preferably 12% or less, and more preferably 10% or less.

SrO: SrO is an essential component for decreasing high temperature viscosity, increasing an average thermal expansion coefficient and decreasing photoelastic constant. The content is from 2 to 10%. In the case where the content is less than 2%, high temperature viscosity is not sufficiently decreased, and melting performance tends to be deteriorated or an average thermal expansion coefficient tends to be excessively decreased. The content is preferably 3% or more. On the other hand, in the case where the content exceeds 10%, the tendency to devitrify a glass is increased, Tg is decreased, chemical durability and weather resistance tend to be deteriorated, or a density is increased. The content is preferably 9% or less, and more preferably 8% or less.

BaO: BaO is an essential component for decreasing high temperature viscosity, increasing an average thermal expansion coefficient and decreasing photoelastic constant. The content is from 1 to 10%. In the case where the content is less than 1%, high temperature viscosity is not sufficiently decreased, and melting performance tends to be deteriorated or an average thermal expansion coefficient tends to be excessively decreased. The content is preferably 2% or more. On the other hand, in the case where the content exceeds 10%, the tendency to decrease Tg, and chemical durability and weather resistance tend to be deteriorated, or a density is increased. The content is preferably 9% or less, and more preferably 7% or less.

ZrO₂: ZrO₂ is a component for increasing chemical durability and weather resistance and increasing Tg, and may be contained up to 3%. In the case where the content exceeds 3%, raw material costs are increased, tendency to devitrify a glass is increased, or a density is increased. The content is preferably 1.5% or less, and more preferably 1% or less. On the other hand, in the case of containing ZrO₂, the content is preferably 0.2% or more, and more preferably 0.5% or more.

TiO₂: TiO₂ increase Tg to be effective to improve chemical durability and weather resistance, but transmittance may be decreased, or solarization may be induced. Therefore, it is preferred in the present invention that TiO₂ is not substantially contained.

The total content of MgO, CaO, SrO and BaO is from 20 to 35%. In the case where the total content is less than 20%, there is the tendency that high temperature viscosity is not sufficiently decreased, melting performance is deteriorated, or an average thermal expansion coefficient is excessively decreased. The total content is preferably 22% or more, and more preferably 24% or more. On the other hand, in the case where the total content is too large, the tendency to devitrify a glass is increased, Tg is decreased, and chemical durability and weather resistance tend to be deteriorated. Alternatively, a density is increased. For this reason, the total content is 35% or less. The total content is preferably 32% or less, and more preferably 29% or less.

Na₂O: Na₂O may be contained up to 1.8% in order to, for example, improve melting performance. In the case where the content exceeds 1.8%, there is the tendency to remarkably decrease Tg and Young's modulus. Furthermore, in the case of using in a glass substrate for a CIGS solar cell having an alkali metal-doped CIGS layer, the formation of an alkali metal diffusion barrier layer is required, and cost when manufacturing the CIGS solar cell may be increased. In the case of using in a glass substrate for a CdTe solar cell, an alkali metal diffuses in a transparent conductive oxide layer (hereinafter referred to as a “TCO layer”) and a CdTe layer, described hereinafter, and power generation efficiency may be decreased. In the case of using in a glass substrate for a display panel, alkali metal ions diffuse in a TFT layer, and long-term driving stability may be impaired.

The content is preferably 1.0% or less, more preferably 0.7% or less, still more preferably 0.5% or less, and particularly preferably 0.3% or less, and most preferably, Na₂O is not substantially be contained. In the case of containing Na₂O, the content is preferably 0.1% or more, and more preferably 0.2% or more.

K₂O: K₂O may be contained up to 1% in order to, for example, improve melting performance. In the case where the content exceeds 1%, Tg and Young's modulus are remarkably decreased, or in the case of an alkali metal-doped CIGS layer, the formation of an alkali metal diffusion barrier layer is required, and cost when manufacturing a CIGS solar cell is increased, or in the case of a CdTc solar cell, an alkali metal diffuses in a TCO layer or a CdTe layer, and power generation efficiency may be decreased. In the case of using in a glass substrate for a display panel, alkali metal ions diffuse in a TFT layer, and long-term driving stability may be deteriorated.

The content is preferably 0.7% or less, more preferably 0.5% or less, and still more preferably 0.3% or less, and particularly preferably K₂O is not substantially contained. On the other hand, in the case of containing K₂O, the content is preferably 0.1% or more, and more preferably 0.2% or more.

Na₂O and K₂O: The total content of Na₂O and K₂O is 2% or less. In the case where the total content exceeds 2%, Tg and Young's modulus may remarkably be decreased. Furthermore, in the case of using in a glass substrate for a CIGS solar cell having an alkali metal-doped CIGS layer, the formation of an alkali metal diffusion barrier layer is required. In the case of using in a glass substrate for a display panel, alkali metal ions diffuse in a TFT layer, and long-term driving stability may be impaired.

The content is preferably 1.5% or less, more preferably 1% or less, still more preferably 0.5% or less, and particularly preferably 0.3% or less, and most preferably those are not substantially contained.

CeO₂ is effective as a refining agent of a glass. However, the cost of raw materials may be increased, transmittance may be decreased or solarization may be induced. Therefore, it is preferred in the present invention that CeO₂ is not substantially contained.

La₂O₃ is effective to increase Tg and decrease high temperature viscosity. For the reasons that a density is increased, the cost for raw materials is increased, and CeO₂ contained in raw material of La₂O₃ is difficult to separate, it is preferred in the present invention that La₂O₃ is not substantially contained.

The glass composition of the invention is preferably a glass composition, comprising, in terms of mol % on the basis of oxides:

from 55 to 70% of SiO₂,

from 5 to 10% of Al₂O₃,

from 0 to 0.5% of B₂O₃,

from 3 to 15% of MgO,

from 3 to 15% of CaO,

from 2 to 10% of SrO,

from 1 to 10% of BaO,

from 0 to 3% of ZrO₂,

from 0 to 1% of Na₂O, and

from 0 to 1% of K₂O,

provided that MgO+CaO+SrO+BaO is from 20 to 35%, and Na₂O+K₂O is from 0 to 1.5%,

wherein the glass composition has a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower.

To improve the refining of a glass, raw materials of SO₃, F, Cl, SnO₂ and Fe₂O₃ may be added to the raw material of the glass matrix composition such that SO₃, F, Cl, SnO₂ and Fe₂O₃ are contained in amount of SO₃: 0.5 parts by mass or less, F: 1.5 parts by mass or less, Cl: 3 parts by mass or less, SnO₂: 0.30 parts by mass or less, and Fe₂O₃: 0.30 parts by mass or less, the total amount thereof being 3 parts by mass or less, per 100 parts by mass of the raw materials of the glass matrix components.

However, in the case of using in a glass substrate for a CdTe solar cell, a tube glass for an evacuated glass tube type heat collector, and a glass substrate for a display panel in which UV curing resin is used in a sealing step of a panel, Fe₂O₃ is preferably 0.03 parts by mass or less, more preferably 0.02 parts by mass or less, still more preferably 0.01 parts by mass or less, and particularly preferably 0.005 parts by mass or less.

Moreover, SnO₂ is preferably 0.30 parts by mass or less, more preferably 0.25 parts by mass or less, and still more preferably 0.20 parts by mass or less. The reason for this is to secure transmittance.

In the case of using Danner process to form a tube glass, it is preferred that Cl is not substantially contained. If Cl is contained, reboiling occurs at a contact face between a molten glass and a sleeve, and bubbles may incorporate in a tube glass.

Furthermore, in view of environmental load, it is preferred that As₂O₃ and Sb₂O₃ are not substantially contained as a refining agent.

Other components may be contained in an amount of 1% or less, respectively, and in the total amount of 5% or less, such that the object of the present invention is not impaired. For example, there is the case that ZnO, Li₂O, WO₃, Nb₂O₅, V₂O₅, Bi₂O₃, MoO₃, TlO₂, P₂O₅ and the like may be contained for the purpose of improving weather resistance, melting performance, devitrification property, UV-cut, refractive index and the like. Float process is preferably used in the case of forming a large area glass substrate. However, in view of stable float forming, it is preferred that ZnO is not substantially contained.

The glass composition of the present invention preferably comprises SiO₂, Al₂O₃, MgO, CaO, SrO, BaO, ZrO₂, Na₂O and K₂O, except for unavoidable impurities. However, the above-described refining agents (SO₃, F, Cl, SnO₂, Fe₂O₃, and the like) are acceptable.

### <Uses of Glass Composition of Present Invention>

The glass composition of the present invention is preferably used in a glass substrate for a solar cell such as CIGS, CZTS or CdTe, or a cover glass for a solar cell.

Moreover, the glass composition is further preferable for use as a tube glass for an evacuated glass tube type heat collector.

Also, the glass composition is further preferable for use as a glass substrate for a display panel.

### <Method for Producing the Glass Substrate of the Present Invention>

A method for producing the glass substrate of the present invention is described below.

In the case of producing the glass substrate for solar cells of the present invention, melting/refining steps and forming step are carried out, similar to the case of producing the conventional sheet glass. A float process and a fusion process (downdraw process) are suitable as the forming method.

A method for forming a sheet glass preferably uses a float process that can easily and stably form a large area glass substrate, with increasing in size of a solar cell and a display.

A method for producing the glass substrate of the present invention is a refining method of a glass having a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower, and containing, in terms of mol % on the basis of oxides, from 20 to 35% of MgO+CaO+SrO+BaO, and containing from 0 to 2% of Na₂O+K₂O, and it is preferable to add

from 0.1 to 0.5 parts by mass of SO₃,

from 0.2 to 3 parts by mass of Cl, and

from 0.05 to 1.5 parts by mass of F,

per 100 parts by mass of raw materials of components of a glass matrix composition, followed by melting and refining.

To have high glass transition temperature, a given average thermal expansion coefficient and low melting temperature in good balance such that the glass transition temperature is 680° C. or higher, the average thermal expansion coefficient is from 50×10⁻⁷ to 70×10⁻⁷/° C., and the temperature at which a viscosity is 10² dPa·s is 1,600° C. or lower, it is preferable to contain MgO+CaO+SrO+BaO in an amount of from 20 to 35%, and to add Na₂O+K₂O in an amount of from 0 to 2%. To refine the glass in a short period of time, it is preferred that from 0.1 to 0.5 parts by mass of SO₃, from 0.2 to 3 parts by mass of Cl, and from 0.05 to 1.5 parts by mass of F, per 100 parts by mass of raw materials of the component of the glass matrix composition, are added, followed by melting and refining.

In the case where SO₃ is less than 0.1 parts by mass, Cl is less than 0.2 parts by mass and F is less than 0.05 parts by mass, bubbles are difficult to expand, and it is difficult to perform refining in a short period of time. In the case where SO₃ is more than 0.5 parts by mass, Cl is more than 3 parts by mass and F is more than 1.5 parts by mass, the possibility of generating bubbles is increased by a stirrer for homogenization and reboiling in the middle of an introduction path to a float bath.

The preferred embodiment of the method for producing the glass substrate of the present invention is described below.

Raw materials are prepared such that the glass substrate obtained has the above-described composition, and the raw materials are continuously introduced in a melting furnace and heated at from 1,450 to 1,650° C. to obtain a molten glass. The molten glass is formed into a ribbon-shaped sheet glass by applying, for example, a float process.

Next, after taking the ribbon-shaped sheet glass out of a float forming furnace, the sheet glass is annealed to a room temperature state by annealing means, followed by cutting, thereby obtaining a glass substrate.

### <Glass Substrate for a CIGS Solar Cell of the Present Invention>

The glass substrate for a CIGS solar cell of the present invention is preferred as a glass substrate for a CIGS solar cell, or a cover glass.

In the case of applying the glass substrate for a CIGS solar cell of the present invention to a glass substrate for a CIGS solar cell, the thickness of a glass substrate is preferably 3 mm or less, more preferably 2 mm or less, and still more preferably 1.5 mm or less. A method for imparting a photoelectric conversion layer of CIGS to the glass substrate is not particularly limited. By using the glass substrate for a CIGS solar cell of the present invention, the heating temperature when forming a photoelectric conversion layer can be from 500 to 700° C., and preferably from 600 to 700° C.

In the case of using the glass substrate for a CIGS solar cell of the present invention in only a glass substrate for a CIGS solar cell, a cover glass and the like are not particularly limited. However, when the glass substrate for a CIGS solar cell of the present invention is used in both the glass substrate for a CIGS solar cell and the cover glass, those have the same average thermal expansion coefficient. Therefore, thermal deformation and the like when fabricating a solar cell do not occur, which is preferred.

### <CIGS Solar Cell in the Present Invention>

The CIGS solar cell in the present invention is described below.

The CIGS solar cell in the present invention has a glass substrate, a cover glass, and a CIGS layer arranged as a photoelectric conversion layer between the glass substrate and the cover glass, wherein at least one of the glass substrate and the cover glass is the glass substrate of the present invention.

An alkali metal compound containing Na is preferably laminated on any one of the glass substrates, a plus electrode such as Mo on the glass substrate, or a precursor of CIGS. In the case where the alkali metal compound containing Na is not laminated, the alkali metal is not sufficiently diffused in the photoelectric conversion layer, and power generation efficiency may be decreased. Examples of the alkali metal compound include NaF, NaCl, Na₂S, Na₂Se, KF, KCl, K₂S, K₂Se and Mo composite oxides, although not particularly limited. Furthermore, two kinds or more of alkali metal compounds may be combined.

In the case of laminating the alkali metal compound, the lamination method is not particularly limited, and any of a sputtering method, a CVD method, an MOCVD method, a vacuum deposition method, a wet method and the like may be applied.

The formation method of the CIGS layer is not particularly limited. The formation method may be a so-called selenization method in which after a precursor comprising constituent elements other than Se as the components contained therein has formed, heat treatment is conducted in H₂Se gas atmosphere, and may be a vacuum deposition method in which each constituent element is physically vacuum-deposited, or a printing method in which an ink is prepared using a CIGS power, and after screen printing, heat treatment is applied to sinter.

### <Glass Substrate for a CdTe Solar Cell of the Present Invention>

The glass substrate for a CdTe solar cell of the present invention is preferred as a glass substrate of a CdTe solar cell, or a cover glass (in the CdTd solar cell, hereinafter referred to as a “back sheet glass”).

In the case of applying the glass substrate for a CdTe solar cell of the present invention to a glass substrate of a CdTe solar cell, the thickness of the glass substrate is preferably 4 mm or less, more preferably 2 mm or less, and still more preferably 1.5 mm or less. A method for imparting a photoelectric conversion layer of CdTc to the glass substrate is not particularly limited. By using the glass substrate for a CdTe solar cell of the present invention, the heating temperature when forming the photoelectric conversion layer can be from 500 to 700° C., and preferably from 600 to 700° C.

In the case of using the glass substrate for a CdTe solar cell of the present invention in only the glass substrate of a CdTe solar cell, the back sheet glass and the like are not particularly limited. However, when the glass substrate for a CdTe solar cell of the present invention is used in both the glass substrate of a CdTe solar cell and the back sheet glass, those have the same average thermal expansion coefficient. Therefore, thermal deformation and the like when fabricating a solar cell do not occur, which is preferred.

### <CdTe Solar Cell of the Present Invention>

Next, the CdTe solar cell of the present invention is described below.

The CdTe solar cell in the present invention has a glass substrate, a back sheet glass, and a photoelectric conversion layer of CdTe arranged between the glass substrate and the back sheet glass, wherein at least the glass substrate is the glass substrate of the present invention.

The structure of the CdTe solar cell of the present invention is not particularly limited. The structure in which a translucent lower electrode is formed on a glass substrate, a window layer and a CdTc layer are formed on the lower electrode, and an upper electrode is then formed, is preferred.

The translucent lower electrode uses, for example, a transparent conductive oxide layer comprising a thin film of ITO. SnO₂ or the like (hereinafter referred to as a “TCO layer”). In forming the CdTe layer, the TCO layer is exposed to high temperature process. In this case, when an alkali metal diffuses in the TCO layer from the glass substrate, film quality of the TCO layer is deteriorated. Alternatively, the alkali metal diffuses up to the CdTe layer, and power generation efficiency may be decreased.

Particularly, in the case of desiring to inhibit the diffusion of an element (for example, an alkaline earth metal) from other glass substrate, a diffusion barrier layer may be formed between the glass substrate and the TCO layer. The diffusion layer is preferably, for example, an SiO₂ layer.

In the case of laminating the above-described lower electrode, window layer, upper electrode and diffusion barrier layer, the lamination method is not particularly limited. For example, any of a sputtering method, a CVD method, an MOCVD method, a molecular beam epitaxial growth (MBE) method, a solution growth (CBD) method, and a wet method may be applied.

Moreover, the formation method of the CdTe layer is not particularly limited. The formation method may be a so-called closed space sublimation (CSS) method in which a source of CdTe is heated and sublimated in an inert gas atmosphere to deposit CdTe on the window layer (the window layer is formed on the lower electrode formed on the glass substrate), and may be a vacuum deposition method in which each constituent element is physically vacuum-deposited, or a printing method in which an ink is prepared using a CdTe powder, and after screen printing, heat treatment is conducted to sinter. Besides above, an MOCVD method, an MBE method or an electrodeposition method may be used.

### <Glass Substrate for a Display Panel of the Present Invention>

The glass substrate for a display panel of the present invention is preferred as a glass substrate for an organic EL display panel, or a glass substrate for an organic EL display panel in which an oxide semiconductor such as IGZO or an organic semiconductor such as pentacene is used in TFT.

In the case of applying the glass substrate for a display panel of the present invention to a glass substrate of a display panel, the thickness of the glass substrate is preferably 2 mm or less, more preferably 1.3 mm or less, still more preferably 0.8 mm or less, particularly 0.5 mm or less, and most preferably 0.3 mm or less. A method for forming TFT on a glass substrate and a kind of TFT formed are not particularly limited.

However, the glass substrate for a display panel of the present invention has an average thermal expansion coefficient in a range of from 50×10⁻⁷ to 70×10⁻⁷/° C., differing from the commercially available alkali-free glass having a thermal expansion coefficient that has been matched to that of silicon TFT (for example, EAGLE XG, manufacture by Corning Incorporated, or AN100, manufactured by Asahi Glass Co., Ltd.), and is therefore preferred in TFT using an oxide semiconductor such as IGZO or an organic semiconductor such as pentacene. Furthermore, the glass substrate for a display panel of the present invention is preferred to use in a display panel for a large-sized television having 50 inches or more using a metal frame.

### EXAMPLES

The present invention is described in more detail by reference to working examples and production examples, but the invention is not limited to those working examples and production examples.

Working examples (Examples 1 to 22 and 26 to 37) of the present invention and comparative examples (Examples 23 to 25 and 38) are shown below. Incidentally, the parenthesis in Tables 1 to 4 indicates a measurement value (by regression calculation).

Raw materials of each component were prepared so as to achieve the compositions shown in Tables 1 to 4, and each resulting mixture was heated and melted at a temperature of 1,600° C. for 30 minutes using a platinum crucible. In melting, a platinum stirrer was inserted, and stirring was conducted for 1 hour to perform homogenization of a glass. The molten glass was flown out of the crucible, formed into a sheet shape, and cooled. Thus, a glass sheet was obtained.

Incidentally, in the above preparation, based on 100 parts by mass of raw materials of components of a glass matrix composition, Fe₂O₃ was added in an amount of 0.05 parts by mass in Examples 18 and 25 to 38, respectively; in amounts of 0.06 parts by mass and 0.08 parts by mass in Examples 23 and 24, respectively; and in an amount of 0.1 parts by mass in Examples 1 to 17 and 19 to 22, respectively. Furthermore, SO₃ was added in an amount of 0.3 parts by mass in Examples 1 to 22 and 24 to 36, respectively, and in an amount of 0.36 parts by mass in Example 23. Cl was added in an amount of 0.5 parts by mass in Examples 1 to 22 and 25 to 38, respectively, and in an amount of 1 parts by mass in Example 23. F was added in an amount of 0.15 parts by mass in Examples 1 to 22, 25 to 35, 37 and 38, respectively; in an amount of 0.14 parts by mass in Example 23; and in an amount of 1.2 parts by mass in Example 36. CeO₂ was added in an amount of 0.05 parts by mass in Example 22.

Residual amount (mol %) of Fe₂O₃ in the glass compositions of Examples 9, 17 and 20 was 0.04%, respectively, and residual amount of Fe₂O₃ in the glass compositions of Examples of Examples 18 and 36 was 0.02%. Residual amount of SO₃ in the glass compositions of Examples 9, 17, 18, 20 and 36 was from 0.01 to 0.07%. Residual amount of Cl in the glass compositions of Examples 9, 17, 18 and 20 was from 0.70 to 1.00%. Residual amount of Cl in the glass composition of Example 36 was 1.65%. Residual amount of F in the glass compositions of Examples 9, 17, 18 and 20 was from 0.30 to 0.60%, and residual amount of F in the glass composition of Example 36 was 3.14%. Residual amount of CeO₂ in the glass composition of Example 22 was 0.02%.

Incidentally, the residual amount of Fe₂O₃, SO₃, Cl, F and CeO₂ in the glass composition was measured by forming a bulk of a glass cut out of a glass sheet into a power shape and evaluating with fluorescent X-ray.

Average thermal expansion coefficient “α” (unit: ×10⁻⁷/° C.), glass transition temperature Tg (unit: ° C.), temperature (T₂) at which viscosity is 10² dPa·s (unit: ° C.), temperature (T₄) at which viscosity is 10⁴ dPa·s (unit: ° C.), devitrification temperature (T_{L}) (unit: ° C.), strain point Tₛₚ (unit: ° C.), annealing point Tₐₚ (unit: ° C.), transmittance V₄₀₀ at wavelength of 400 nm (unit: %), average transmittance Vₐ, (unit: %), density d (unit: g/cm³), Young's modulus E (unit: GPa), alkali metal and alkaline earth metal amounts precipitated on the surface of a glass substrate after maintaining under specific conditions, as weather resistance (unit: ng/cm²), alkali metal amount diffused in a TCO layer from a glass substrate, in a TCO layer-attached glass maintained under specific conditions after film-forming a TOC layer, as alkali metal diffuseness (unit: Na/Zn Count), and photoelastic constant (unit: nm/MPa/cm) of the glass sheet thus obtained were measured, and the results obtained are shown in Tables 1 to 4. Measurement method of each physical property is shown below.

Incidentally, in the working examples, there are physical properties measured on a glass sheet and a glass substrate, but each physical property is the same value between the glass composition and the glass sheet, and between the glass composition and the glass substrate. The glass sheet obtained is subjected to processing and polishing, thereby a glass substrate can be obtained.

(1) Glass transition temperature (Tg): “Tg” was a value measured using a differential thermal dilatometer (TMA) and was obtained according to JIS R3010-3 (2001).
(2) Average thermal expansion coefficient at from 50 to 350° C. (a): “a” was measured using a differential thermal dilatometer (TMA) and was obtained according to JIS R3102 (1995).
(3) Viscosity: Temperature T₂ when viscosity η is 10² dPa·s (standard temperature of melting performance) and temperature T₄ when viscosity η is 10⁴ dPa·s (standard temperature of formability), were measured using a rotary viscometer.
(4) Devitrification temperature (I_{L}): Glass bulk (5 g) cut out of a glass sheet was placed on a platinum dish, and was maintained in an electric furnace at a given temperature for 17 hours. Maximum value of a temperature at which crystal does not precipitate on the surface and in the inside of the glass bulk after maintaining was defined as a devitrification temperature.
(5) Density (d): About 20 g of a glass which does not contain bubbles was measured by Archimedes method.
(6) Young's modulus (E): measurement was conducted for glass sheets, having a thickness of from 4 to 10 mm and a size of about 4 cm×4 cm, by an ultrasonic pulse method.
(7) Strain point (Tₛₚ) and annealing point (Tₐₚ): measurements were conducted according to JIS R3103-2.
(8) Transmittance (V₄₀₀, average transmittance Vₐᵥₑ): A sample (glass substrate) obtained by mirror-polishing both surfaces of a glass sheet, having a thickness of 1 mm and a size of 4 cm×4 cm, with cerium oxide was prepared, transmittance at a wavelength of from 300 to 2,000 nm was measured, transmittance “V₄₀₀” (unit: %) at 400 nm was measured, and average transmittance “Vₐᵥₑ” (unit: %) at from 450 to 1,100 nm was calculated.
(9) Weather resistance test: Both surfaces of a glass sheet, having a thickness of from 1 to 2 mm and a size of 4 cm×4 cm, were minor-polished with cerium oxide and then cleaned using calcium carbonate and a neutral detergent to obtain a glass substrate. The glass substrate obtained was placed in a highly accelerated stress test apparatus (trade name: unsaturated type pressure cooker EHS-411M, manufactured by Espec Corporation), and was allowed to remain in a water vapor atmosphere of 120° C. and 0.2 MPa for 20 hours. The glass substrate after the test and 20 ml of ultrapure water were placed in a cleaned zippered plastic bag, precipitates on the surface were dissolved with a supersonic cleaning machine for 10 minutes, and eluted substances of elements of an alkali metal and an alkaline earth metal were quantitated (eluted mass/sample surface area) (unit: ng/cm²) by a ICP spectroscopy.
(10) Alkali metal diffuseness (DNa₆₀₀ and DNa₆₀): Both surfaces of a glass sheet, having a thickness of from 1 to 4 mm and a size of 5 cm×5 cm, were mirror-polished with cerium oxide and then cleaned using calcium carbonate and a neutral detergent to obtain a glass substrate. An alkali metal barrier layer of SiO₂ was formed in a thickness of about 40 nm on only the glass substrate, obtained from the glass sheet of Example 24, by sputtering.

ZnO film, doped with 5.7 wt % of Ga (GZO film), having a thickness of about 100 nm was film-formed, as a film corresponding to a TCO layer on the respective glass substrates, by sputtering under the conditions of temperature of about 100° C. for a glass substrate, thereby obtaining each sample.

Those samples were maintained at 600° C. and 650° C. in N₂ atmosphere for 30 minutes, respectively. The amount of Na₂O in the GZO film was quantitated with SIMS, and the value standardized by Zn was defined as alkali metal diffuseness (the alkali metal diffuseness at 600° C. was defined as DNa₆₀₀ and the alkali metal diffuseness at 650° C. was defined as DNa₆₅₀) (unit: Na/Zn count).

Incidentally, the alkali metal diffuseness DNa₆₀₀ in the glass substrate sample of Example 24 in the table is indicated by “< >”. This is to distinguish from other examples because the alkali metal diffusion barrier layer is present between the glass and the GZO layer. Furthermore, the reason that the column of DNa₆₀₀ of the above glass is “<->” is that when heated to 650° C., deformation occurred due to low Tg, and quantitation by SIMS could not be performed.

(11) Photoelastic constant: Photoelastic constant was measured by a disk compression method (measurement wavelength: 546 nm)

TABLE 1

| mol % | Ex. 1 | Ex. 2 | Ex. 3 | Ex. 4 | Ex. 5 | Ex. 6 |
|---|---|---|---|---|---|---|
| SiO₂ | 64.0 | 64.5 | 64.0 | 65.0 | 66.0 | 65.5 |
| Al₂O₃ | 9.0 | 8.0 | 7.0 | 7.0 | 7.0 | 7.5 |
| B₂O₃ | 0 | 0 | 0 | 0 | 0 | 0 |
| MgO | 8.0 | 10.5 | 8.0 | 8.0 | 7.0 | 7.0 |
| CaO | 8.0 | 7.0 | 8.0 | 8.0 | 8.0 | 9.0 |
| SrO | 8.0 | 8.0 | 8.0 | 8.0 | 7.0 | 7.0 |
| BaO | 3.0 | 2.0 | 3.0 | 2.0 | 4.0 | 2.0 |
| TiO₂ | 0 | 0 | 0 | 0 | 0 | 0 |
| ZrO₂ | 0 | 0 | 2.0 | 1.0 | 1.0 | 1.0 |
| Na₂O | 0 | 0 | 0 | 0.5 | 0 | 0.5 |
| K₂O | 0 | 0 | 0 | 0.5 | 0 | 0.5 |
| La₂O₃ | 0 | 0 | 0 | 0 | 0 | 0 |
| MgO + CaO + SrO + BaO | 27.0 | 27.5 | 27.0 | 26.0 | 26.0 | 25.0 |
| Na₂O + K₂O | 0 | 0 | 0 | 1.0 | 0 | 1.0 |
| Tg (° C.) | 736 | 733 | 742 | 721 | 737 | 727 |
| α₅₀₋₃₅₀ (×10⁻⁷/° C.) | 55 | 53 | 53 | 56 | 53 | 56 |
| d (g/cm³) | 2.82 | 2.78 | 2.88 | 2.81 | 2.85 | 2.78 |
| E (GPa) | (87) | (88) | (90) | (88) | (87) | (87) |
| Tₛₚ (° C.) | — | — | — | — | — | — |
| Tₐₚ (° C.) | — | — | — | — | — | — |
| T₂ (° C.) | 1547 | 1546 | 1523 | 1541 | (1536) | (1535) |
| T₄ (° C.) | 1201 | 1197 | 1190 | 1191 | (1203) | (1195) |
| T_{L} (° C.) | 1240 | 1250 | 1250 | 1200 | 1240 | 1180 |
| V₄₀₀ (%) | — | — | — | — | — | — |
| Vₐᵥₑ (%) | — | — | — | — | — | — |
| Weather resistance | — | — | — | — | — | — |
| (ng/cm²) | | | | | | |
| DNa₆₀₀ (Na/Zn count) | — | — | — | — | — | — |
| DNa₆₅₀ (Na/Zn count) | — | — | — | — | — | — |
| Photoelastic constant | (23.3) | (23.5) | (24.3) | (24.5) | (24.2) | (24.9) |
| (nm/MPa/cm) | | | | | | |
| mol % | Ex. 7 | Ex. 8 | Ex. 9 | Ex. 10 | Ex. 11 | Ex. 12 |
| SiO₂ | 66.0 | 66.0 | 66.0 | 66.0 | 65.0 | 65.0 |
| Al₂O₃ | 7.5 | 7.5 | 7.0 | 7.0 | 7.5 | 7.0 |
| B₂O₃ | 0 | 0 | 0 | 0 | 0 | 0 |
| MgO | 9.0 | 9.0 | 7.5 | 7.5 | 8.5 | 8.5 |
| CaO | 7.0 | 6.0 | 7.5 | 7.5 | 8.5 | 8.5 |
| SrO | 6.0 | 5.0 | 7.0 | 7.0 | 7.0 | 7.0 |
| BaO | 3.0 | 5.0 | 3.2 | 3.0 | 3.2 | 3.2 |
| TiO₂ | 0 | 0 | 0 | 0 | 0 | 0 |
| ZrO₂ | 1.5 | 1.5 | 1.5 | 1.5 | 0 | 0.5 |
| Na₂O | 0 | 0 | 0.2 | 0.3 | 0.2 | 0.2 |
| K₂O | 0 | 0 | 0.1 | 0.2 | 0.1 | 0.1 |
| La₂O₃ | 0 | 0 | 0 | 0 | 0 | 0 |
| MgO + CaO + SrO + BaO | 25.0 | 25.0 | 25.2 | 25.0 | 27.2 | 27.2 |
| Na₂O + K₂O | 0 | 0 | 0.3 | 0.5 | 0.3 | 0.3 |
| Tg (° C.) | 746 | 745 | 736 | 732 | 725 | 728 |
| α₅₀₋₃₅₀ (×10⁻⁷/° C.) | 51 | 52 | 55 | 55 | 57 | 55 |
| d (g/cm³) | 2.80 | 2.84 | 2.83 | 2.81 | 2.81 | 2.81 |
| E (GPa) | (89) | (88) | (88) | (88) | (87) | (88) |
| Tₛₚ (° C.) | — | 700 | 693 | — | — | — |
| Tₐₚ (° C.) | — | 750 | 743 | — | — | — |
| T₂ (° C.) | 1578 | 1585 | 1566 | (1541) | (1525) | (1518) |
| T₄ (° C.) | 1230 | 1235 | 1218 | (1207) | (1187) | (1185) |
| T_{L} (° C.) | 1220 | 1220 | 1200 | 1200 | 1180 | 1180 |
| V₄₀₀ (%) | — | — | 89.0 | — | 89.4 | 88.7 |
| Vₐᵥₑ (%) | — | — | 86.6 | — | 87.9 | 88.3 |
| Weather resistance | — | — | — | — | — | — |
| (ng/cm²) | | | | | | |
| DNa₆₀₀ (Na/Zn count) | — | — | — | — | — | — |
| DNa₆₅₀ (Na/Zn count) | — | — | — | — | — | — |
| Photoelastic constant | 24.9 | 24.5 | (24.8) | (24.9) | (23.6) | (23.9) |
| (nm/MPa/cm) | | | | | | |

TABLE 2

| mol % | Ex. 13 | Ex. 14 | Ex. 15 | Ex. 16 | Ex. 17 | Ex. 18 |
|---|---|---|---|---|---|---|
| SiO₂ | 57.0 | 69.0 | 65.0 | 60.0 | 64.0 | 64.0 |
| Al₂O₃ | 9.5 | 5.5 | 5.5 | 6.0 | 7.5 | 7.5 |
| B₂O₃ | 0 | 0 | 0 | 0 | 0 | 0 |
| MgO | 10.0 | 6.0 | 14.0 | 10.0 | 10.0 | 10.0 |
| CaO | 13.0 | 6.0 | 5.2 | 10.0 | 7.0 | 7.0 |
| SrO | 5.0 | 4.0 | 3.0 | 9.0 | 6.5 | 6.5 |
| BaO | 5.0 | 9.0 | 6.0 | 5.0 | 4.2 | 4.2 |
| TiO₂ | 0 | 0 | 0 | 0 | 0 | 0 |
| ZrO₂ | 0 | 0.5 | 0 | 0 | 0.5 | 0.5 |
| Na₂O | 0.3 | 0 | 0.8 | 0 | 0.2 | 0.2 |
| K₂O | 0.2 | 0 | 0.5 | 0 | 0.1 | 0.1 |
| La₂O₃ | 0 | 0 | 0 | 0 | 0 | 0 |
| MgO + CaO + SrO + BaO | 33.0 | 25.0 | 28.2 | 34.0 | 27.7 | 27.7 |
| Na₂O + K₂O | 0.5 | 0 | 1.3 | 0 | 0.3 | 0.3 |
| Tg (° C.) | 726 | 724 | 698 | 712 | 725 | — |
| α₅₀₋₃₅₀ (×10⁻⁷/° C.) | 63 | 57 | 59 | 67 | 56 | — |
| d (g/cm³) | 2.94 | 2.92 | 2.82 | 2.99 | 2.85 | — |
| E (GPa) | (90) | (84) | (87) | (89) | 87 | (87) |
| Tₛₚ (° C.) | — | — | — | — | — | — |
| Tₐₚ (° C.) | — | — | — | — | — | — |
| T₂ (° C.) | (1413) | (1571) | (1518) | (1410) | 1542 | — |
| T₄ (° C.) | (1125) | (1227) | (1189) | (1108) | 1195 | — |
| T_{L} (° C.) | 1220 | 1220 | 1220 | 1180 | 1160 | — |
| V₄₀₀ (%) | 87.7 | 88.9 | 89.3 | 88.1 | 89.0 | 89.8 |
| Vₐᵥₑ (%) | 87.8 | 87.6 | 88.3 | 87.7 | 88.0 | 90.0 |
| Weather resistance | 29 | 53 | 54 | 80 | 32 | — |
| (ng/cm²) | | | | | | |
| DNa₆₀₀ (Na/Zn count) | — | — | — | — | — | 0.12 |
| DNa₆₅₀ (Na/Zn count) | — | — | — | — | — | 0.11 |
| Photoelastic constant | 21.6 | 23.8 | (23.4) | (21.2) | (23.4) | (23.4) |
| (nm/MPa/cm) | | | | | | |

| mol % | Ex. 19 | Ex. 20 | Ex. 21 | Ex. 22 | Ex. 23 | Ex. 24 |
|---|---|---|---|---|---|---|
| SiO₂ | 68.0 | 63.0 | 66.0 | 66.0 | 66.2 | 71.3 |
| Al₂O₃ | 7.5 | 7.5 | 7.0 | 7.0 | 11.3 | 1.0 |
| B₂O₃ | 0 | 0 | 0 | 0 | 7.6 | 0 |
| MgO | 5.5 | 10.0 | 7.5 | 7.5 | 5.3 | 5.8 |
| CaO | 5.5 | 7.5 | 7.5 | 7.5 | 4.7 | 9.1 |
| SrO | 7.0 | 6.5 | 7.0 | 7.0 | 4.9 | 0 |
| BaO | 5.0 | 4.0 | 4.0 | 4.0 | 0 | 0 |
| TiO₂ | 0 | 0 | 1.0 | 0 | 0 | 0 |
| ZrO₂ | 1.0 | 0.5 | 0 | 0 | 0 | 0 |
| Na₂O | 0.3 | 0.2 | 0 | 0 | 0 | 12.5 |
| K₂O | 0.2 | 0.8 | 0 | 0 | 0 | 0.3 |
| La₂O₃ | 0 | 0 | 0 | 1.0 | 0 | 0 |
| MgO + CaO + SrO + BaO | 23.0 | 28.0 | 26.0 | 26.0 | 14.9 | 14.9 |
| Na₂O + K₂O | 0.5 | 1.0 | 0 | 0 | 0 | 12.8 |
| Tg (° C.) | 737 | 719 | 727 | 729 | 720 | 548 |
| α₅₀₋₃₅₀ (×10⁻⁷/° C.) | 54 | 60 | 55 | 57 | 38 | 88 |
| d (g/cm³) | 2.85 | 2.84 | 2.83 | 2.91 | 2.50 | 2.51 |
| E (GPa) | (85) | (86) | (85) | (85) | (72) | (72) |
| Tₛₚ (° C.) | — | — | — | — | 666 | 516 |
| Tₐₚ (° C.) | — | — | — | — | 725 | 552 |
| T₂ (° C.) | (1588) | 1534 | (1540) | (1517) | 1670 | 1441 |
| T₄ (° C.) | (1239) | 1195 | (1196) | (1180) | 1284 | 1024 |
| T_{L} (° C.) | 1140 | 1180 | 1220 | 1220 | 1270 | 1025 |
| V₄₀₀ (%) | 89.4 | 88.6 | 84.7 | 83.9 | 89.8 | 91.1 |
| Vₐᵥₑ (%) | 86.9 | 88.3 | 86.7 | 84.6 | 90.3 | 89.7 |
| Weather resistance | 47 | — | 29 | 41 | 17 | 999 |
| (ng/cm²) | | | | | | |
| DNa₆₀₀ (Na/Zn count) | — | — | — | — | — | <2.32> |
| DNa₆₅₀ (Na/Zn count) | — | — | — | — | — | <—> |
| Photoelastic constant | (24.7) | 23.2 | 23.5 | — | 31.2 | 26 |
| (nm/MPa/cm) | | | | | | |

TABLE 3

| mol % | Ex. 25 | Ex. 26 | Ex. 27 | Ex. 28 | Ex. 29 | Ex. 30 |
|---|---|---|---|---|---|---|
| SiO₂ | 62.3 | 63.5 | 65.0 | 65.0 | 65.0 | 65.0 |
| Al₂O₃ | 7.3 | 7.4 | 7.7 | 7.5 | 7.5 | 7.5 |
| B₂O₃ | 0 | 0 | 0 | 0 | 0 | 0 |
| MgO | 9.7 | 9.9 | 11.0 | 11.0 | 11.0 | 11.0 |
| CaO | 6.8 | 7.0 | 7.5 | 8.0 | 6.0 | 4.0 |
| SrO | 6.3 | 6.4 | 5.0 | 4.7 | 6.7 | 8.7 |
| BaO | 4.1 | 4.2 | 2.0 | 2.0 | 2.0 | 2.0 |
| TiO₂ | 0 | 0 | 0 | 0 | 0 | 0 |
| ZrO₂ | 0.5 | 0.5 | 0.5 | 0.5 | 0.5 | 0.5 |
| Na₂O | 2.9 | 1.0 | 1.0 | 1.0 | 1.0 | 1.0 |
| K₂O | 0.1 | 0.1 | 0.3 | 0.3 | 0.3 | 0.3 |
| La₂O₃ | 0 | 0 | 0 | 0 | 0 | 0 |
| MgO + CaO + SrO + BaO | 26.9 | 27.5 | 25.5 | 25.7 | 25.7 | 25.7 |
| Na₂O + K₂O | 3.0 | 1.1 | 1.3 | 1.3 | 1.3 | 1.3 |
| Tg (° C.) | 683 | 716 | 726 | 725 | 717 | 720 |
| α₅₀₋₃₅₀ (×10⁻⁷/° C.) | 66 | 60 | 53 | 54 | 55 | 56 |
| d (g/cm³) | 2.86 | 2.86 | 2.73 | 2.73 | 2.76 | 2.79 |
| E (GPa) | 86 | 87 | 88 | 87 | 87 | 87 |
| Tₛₚ (° C.) | — | — | — | — | — | — |
| Tₐₚ (° C.) | — | — | — | — | — | — |
| T₂ (° C.) | (1489) | (1510) | (1540) | (1535) | (1541) | (1547) |
| T₄ (° C.) | (1156) | (1183) | (1202) | (1198) | (1201) | (1204) |
| T_{L} (° C.) | 1160 | 1160 | 1190 | 1190 | 1220 | 1200 |
| V₄₀₀ (%) | — | — | — | — | — | — |
| Vₐᵥₑ (%) | — | — | — | — | — | — |
| Weather resistance | — | — | — | — | — | — |
| (ng/cm²) | | | | | | |
| DNa₆₀₀ (Na/Zn count) | 0.39 | 0.14 | — | — | — | — |
| DNa₆₅₀ (Na/Zn count) | 0.53 | 0.14 | — | — | — | — |
| Photoelastic constant | (24.4) | (23.7) | (24.9) | (24.9) | (24.6) | 24.2 |
| (nm/MPa/cm) | | | | | | |
| mol % | Ex. 31 | Ex. 32 | Ex. 33 | Ex. 34 | Ex. 35 | Ex. 36 |
| SiO₂ | 64.5 | 64.5 | 65.0 | 64.5 | 63.0 | 63.0 |
| Al₂O₃ | 7.7 | 7.7 | 7.7 | 8.0 | 8.0 | 8.5 |
| B₂O₃ | 0 | 0 | 0.3 | 0 | 0 | 0 |
| MgO | 11.5 | 11.5 | 11.2 | 12.0 | 12.0 | 12.0 |
| CaO | 4.5 | 4.5 | 8.0 | 7.5 | 8.0 | 8.0 |
| SrO | 8.0 | 7.0 | 4.5 | 5.0 | 5.0 | 5.0 |
| BaO | 2.5 | 3.5 | 2.0 | 1.8 | 2.5 | 2.0 |
| TiO₂ | 0 | 0 | 0 | 0 | 0 | 0 |
| ZrO₂ | 0 | 0 | 0 | 0 | 0.2 | 0.2 |
| Na₂O | 1.0 | 1.0 | 1.0 | 1.0 | 1.0 | 1.0 |
| K₂O | 0.3 | 0.3 | 0.3 | 0.2 | 0.3 | 0.3 |
| La₂O₃ | 0 | 0 | 0 | 0 | 0 | 0 |
| MgO + CaO + SrO + BaO | 26.5 | 26.5 | 25.7 | 26.3 | 27.5 | 27.0 |
| Na₂O + K₂O | 1.3 | 1.3 | 1.3 | 1.2 | 1.3 | 1.3 |
| Tg (° C.) | 716 | 713 | 707 | 718 | 700 | 700 |
| α₅₀₋₃₅₀ (×10⁻⁷/° C.) | 58 | 58 | 55 | 56 | 59 | 55 |
| d (g/cm³) | 2.79 | 2.80 | 2.71 | 2.72 | 2.77 | 2.75 |
| E (GPa) | 87 | 87 | (88) | 89 | 89 | 90 |
| Tₛₚ (° C.) | — | — | — | — | — | — |
| Tₐₚ (° C.) | — | — | — | — | — | — |
| T₂ (° C.) | (1540) | (1541) | (1541) | (1535) | (1510) | 1518 |
| T₄ (° C.) | (1198) | (1202) | (1195) | (1197) | (1183) | 1171 |
| T_{L} (° C.) | 1200 | 1190 | 1200 | 1200 | 1190 | 1200 |
| V₄₀₀ (%) | — | — | — | — | — | — |
| Vₐᵥₑ (%) | — | — | — | — | — | — |
| Weather resistance | — | — | — | — | — | — |
| (ng/cm²) | | | | | | |
| DNa₆₀₀ (Na/Zn count) | — | — | — | — | — | 0.13 |
| DNa₆₅₀ (Na/Zn count) | — | — | — | — | — | 0.13 |
| Photoelastic constant | (23.8) | 23.7 | (24.7) | (24.5) | 24.0 | (24.2) |
| (nm/MPa/cm) | | | | | | |

TABLE 4

| mol % | Ex. 37 | Ex. 38 |
|---|---|---|
| SiO₂ | 63.5 | 63.5 |
| Al₂O₃ | 8.5 | 8.5 |
| B₂O₃ | 0 | 0 |
| MgO | 12.0 | 12.0 |
| CaO | 8.0 | 8.0 |
| SrO | 4.0 | 3.5 |
| BaO | 2.0 | 2.0 |
| TiO₂ | 0 | 0 |
| ZrO₂ | 0.2 | 0.2 |
| Na₂O | 1.5 | 2.0 |
| K₂O | 0.3 | 0.3 |
| La₂O₃ | 0 | 0 |
| MgO + CaO + SrO + BaO | 26.0 | 25.5 |
| Na₂O + K₂O | 1.8 | 2.3 |
| Tg (° C.) | 706 | 703 |
| α₅₀₋₃₅₀ (×10⁻⁷/° C.) | 57 | 56 |
| d (g/cm³) | 2.71 | 2.70 |
| E (GPa) | 88 | 88 |
| Tₛₚ (° C.) | — | — |
| Tₐₚ (° C.) | — | — |
| T₂ (° C.) | (1530) | (1531) |
| T₄ (° C.) | (1194) | (1192) |
| T_{L} (° C.) | 1220 | 1230 |
| V₄₀₀ (%) | — | — |
| Vₐᵥₑ (%) | — | — |
| Weather resistance (ng/cm²) | — | — |
| DNa₆₀₀ (Na/Zn count) | 0.22 | 0.42 |
| DNa₆₅₀ (Na/Zn count) | 0.23 | 0.53 |
| Photoelastic constant (nm/MPa/cm) | (24.8) | (25.1) |

As is apparent from Tables 1 to 4, the glass compositions of the working examples (Examples 1 to 17, 19 to 22 and 26 to 37) are that the glass transition temperature “Tg” is high as 680° C. or higher, the average coefficient “a” of thermal expansion is from 50×10⁻⁷ to 70×10⁻⁷/° C., and the T₂ is 1,600° C. or lower. Therefore, all of high glass transition temperature, a given average thermal expansion coefficient, and low glass melting temperature can be achieved, and as a result, by using the glass composition of the present invention, a glass substrate for solar cells having high power generation efficiency, and a tube glass for an evacuated glass tube type heat collector having high solar heat collection efficiency can be provided. Furthermore, when manufacturing a glass, a glass having high productivity and high quality can be obtained. Additionally, weather resistance is good, and long-term reliability can be expected.

Incidentally, the glass composition of Examples 18 is also satisfied with the respective properties.

In the case of using the glass substrate obtained from the working examples in solar cells, the CIGS layer does not separate from the electrode layer-attached glass substrate in the CIGS solar cell, and the CdTe layer does not separate from the CdTc layer in the CdTe solar cell. Furthermore, in fabricating a solar cell (specifically, in laminating the glass substrate and the cover glass by heating such that the photoelectric conversion layer such as a CIGS layer or a CdTe layer is sandwiched therebetween), the glass substrate is difficult to deform, and power generation efficiency is further excellent. Particularly, Examples 9 and 11 to 22 are that an average transmittance at a wavelength of from 450 to 1,100 nm and the transmittance at a wavelength of 400 nm are sufficiently high, and power generation efficiency is excellent.

Incidentally, regarding the glass compositions of Examples 1 to 8, 10 and 26 to 37, the transmittance was high.

In view of the result of the alkali metal diffuseness of the glass compositions of the working examples (Examples 18, 26, 36 and 37), even in the case of increasing the temperature from 600° C. to 650° C., the value of alkali metal diffuseness is small, and change was not observed. From this fact, it is considered that in the case of using the glass substrates obtained from the glass compositions of the working examples (Examples 18, 26, 36 and 37) in the CdTe solar cell, the alkali metal diffusion in the TCO layer and the photoelectric conversion layer is slight. For this reason, formation of the alkali metal diffusion barrier layer is not necessary, one step can be reduced from a cell production process, and superiority of cost can be expected. Furthermore, because deterioration of the TCO layer due to alkali metal diffusion does not cause, the temperature at the time of CdTe film formation can be increased, and improvement in crystallinity of CdTe and improvement in power generation efficiency can be expected.

Incidentally, the property of inhibiting diffusion of an alkali metal is excellent in the glass compositions of Examples 18, 26, 36 and 37 having large Na₂O content. From this fact, it is presumed that the property of inhibiting diffusion of an alkali metal is similarly excellent even in the glass compositions of other working examples having the Na₂O content smaller than that of those Examples.

The glass substrates obtained from the glass compositions of the working examples have excellent property of inhibiting diffusion of an alkali metal, and from this fact, it is expected that in the case of using those in a display panel such as an organic EL display, improvement in long-term reliability can be expected.

On the other hand, according to the glass composition of the comparative example (Example 23), T₂ exceeds 1,600° C., and therefore, productivity is poor. Furthermore, an average coefficient “α” of thermal expansion is too low, and layer separation may occur after formation of the photoelectric conversion layer.

Furthermore, because the glass composition contains a large amount of B₂O₃, load to glass manufacturing facilities is increased.

Since the comparative example (Example 24) has low Tg, the glass substrate deforms easily when forming the photoelectric conversion layer. Furthermore, the elution amount of elements of alkali metals and alkaline earth metals in the weather resistance evaluation is large, and therefore, the weather resistance may be deteriorated. Even though the photoelectric conversion layer has been formed after forming the alkali metal diffusion barrier layer, the alkali metal diffuseness tends to show large value as compared with the working examples. This is considered to be due to that the amount of alkali metal oxides in the components of the glass matrix composition is large and Tg of the glass substrate is low, and as a result, mobility of the alkali metals in the glass is large by the influence of viscosity. Furthermore, because Tg is low, it is difficult to increase a temperature during a process in forming the photoelectric conversion layer, and improvement in power generation efficiency is difficult to be achieved. Moreover, in the case of using in a display panel, there is a possibility that a problem occurs with long-term reliability.

According to the comparative examples (Example 38 and Example 25), Na₂O is contained in amounts of 2.0 mol % and 2.9 mol %, respectively. Therefore, the value of the alkali metal diffuseness is larger than that in the working examples. Furthermore, because the increase in alkali metal diffuseness by increase of temperature is observed, the temperature during a process in forming the photoelectric conversion layer cannot be increased. For this reason, improvement in power generation efficiency cannot be expected, alternatively because it is necessary to form the alkali metal diffusion barrier layer, one step is increased in a cell manufacturing process, and process superiority is poor. In the case of using in a display panel, there is a possibility that a problem occurs with long-term reliability.

The glass composition of the present invention is preferable as a glass substrate for solar cells such as CIGS, CZTS or CdTe. Furthermore, the glass composition is effective as a lube glass for an evacuated glass tube type heat collector. Furthermore, the glass composition is preferable as a glass substrate for a display panel.

While the invention has been described in detail and with reference to specific embodiments thereof, it will be apparent to one skilled in the art that various changes and modifications can be made therein without departing from the spirit and scope of the invention.

This application is based on Japanese Patent Application No. 2011-025148 filed on Feb. 8, 2011, the contents of which are incorporated herein by way of reference.

### INDUSTRIAL APPLICABILITY

The glass composition of the present invention can have high glass transition temperature, a given average thermal expansion coefficient and low melting temperature in good balance, and by using the glass composition of the present invention, a glass substrate for solar cells having high power generation efficiency, a tube glass for an evacuated glass tube type heat collector having high solar heat collection efficiency, and a glass substrate for a display panel can be provided. Furthermore, when manufacturing a glass, a glass substrate and a tube glass, having high productivity and high quality, can be obtained.

1. A glass composition comprising, in terms of mol % on the basis of oxides:
from 55 to 70% of SiO₂,
from 5 to 10% of Al₂O₃,
from 0 to 0.5% of B₂O₃,
from 3 to 15% of MgO,
from 3 to 15% of CaO,
from 2 to 10% of SrO,
from 1 to 10% of BaO,
from 0 to 3% of ZrO₂,
from 0 to 1.8% of Na₂O, and
from 0 to 1% of K₂O,
provided that MgO+CaO+SrO+BaO is from 20 to 35%, and Na₂O+K₂O is from 0 to 2%,
wherein the glass composition has a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower.

2. The glass composition according to claim 1, comprising, in terms of mol % on the basis of oxides:
from 55 to 70% of SiO₂,
from 5 to 10% of Al₂O₃,
from 0 to 0.5% of B₂O₃,
from 3 to 15% of MgO,
from 3 to 15% of CaO,
from 2 to 10% of SrO,
from 1 to 10% of BaO,
from 0 to 3% of ZrO₂,
from 0 to 1% of Na₂O, and
from 0 to 1% of K₂O,
provided that MgO+CaO+SrO+BaO is from 20 to 35%, and Na₂O+K₂O is from 0 to 1.5%,
wherein the glass composition has a glass transition temperature of 680° C. or higher, an average thermal expansion coefficient of from 50×10⁻⁷ to 70×10⁻⁷/° C., and a temperature at which a viscosity is 10² dPa·s of 1,600° C. or lower.

3. The glass composition according to claim 1, comprising, in terms of mol % on the basis of oxides:
from 59 to 67% of SiO₂,
from 5 to 8% of Al₂O₃,
from 0 to 0.3% of B₂O₃,
from 6 to 10% of MgO,
from 6 to 10% of CaO,
from 3 to 9% of SrO,
from 2 to 7% of BaO,
from 0 to 1% of ZrO₂,
from 0 to 1% of Na₂O, and
from 0 to 1% of K₂O,
provided that MgO+CaO+SrO+BaO is from 24 to 29%, and Na₂O+K₂O is from 0 to 1.5%,
wherein the glass composition has a glass transition temperature of 700° C. or higher, an average thermal expansion coefficient of from 50×10⁻⁷ to 60×10⁻⁷/° C., and a temperature at which a viscosity is 10² dPa·s of 1,580° C. or lower.

4. A glass substrate for solar cells, comprising the glass composition according to claim 1.

5. A glass substrate for a CIGS solar cell, comprising the glass composition according to claim 1.

6. A glass substrate for a CdTe solar cell, comprising the glass composition according to claim 1.

7. A glass substrate for a display panel, comprising the glass composition according to claim 1.
